(19) United States
(12) Patent Application Publication
(10) Pub. No.: US 2012/0229399 A1
(43) Pub. Date: Sep. 13, 2012

(54) ELECTRONIC DEVICE

(76) Inventors: Hiroki Kobayashi, Daito-shi (JP); Hiroyuki Okamoto, Daito-shi (JP)

(21) Appl. No.: 13/416,317

(22) Filed: Mar. 9, 2012

(30) Foreign Application Priority Data
Mar. 11, 2011 (JP) 2011054031

(51) Int. Cl. G06F 3/041

(52) U.S. Cl. 345/173

(57) ABSTRACT

An electronic device and methods are disclosed. The electronic device comprises a plurality of touch panels on a plurality of display screens respectively including a first touch panel on a first display screen and a second touch panel on the second display screen. If a predefined area on the first touch panel is moved from a first location to a second location in a direction toward the second touch panel, a notification is displayed in an area between the first location and the second location on the first display screen.

### CROSS-REFERENCE TO RELATED APPLICATION

The present application claims priority under 35 U.S.C. §119 to Japanese Patent Application No. 2011-054031, filed on Mar. 11, 2011, entitled “ELECTRONIC DEVICE”. The content of which is incorporated by reference herein in its entirety.

### FIELD

Embodiments of the present disclosure relate generally to electronic devices, and more particularly relate to a mobile electronic device with improved operability.

### BACKGROUND

Electronic devices in which an operation system as a platform is installed and which are capable of displaying a variety of information and running various applications are known. These kinds of electronic devices have a touch panel on a display screen capable of displaying information, and a user is able to perform various operations by touching the touch panel.

However, when an operation system or an application gives a notice of a variety of information such as an alarm notification and an email reception notification, the notified information is displayed on a display screen by a user's operation. In this case, the information is displayed only on the display screen. For this reason, the display area is narrow, and all information may not be able to be displayed. When another application has been running on the other display screen, the notified information may also mislead a user into thinking that the notified information relates to the application.

### SUMMARY

An electronic device and methods are disclosed. The electronic device comprises a plurality of touch panels on a plurality of display screens respectively including a first touch panel on a first display screen and a second touch panel on the second display screen. If a predefined area on the first touch panel is moved from a first location to a second location in a direction toward the second touch panel, a notification is displayed in an area between the first location and the second location on the first display screen.

In an embodiment of the present disclosure, an electronic device comprises a plurality of display screens, a plurality of touch panels on the display screens respectively, a memory and a control module. The plurality of display screens comprises a first display screen and a second display screen. The plurality of touch panels comprises a first touch panel on the first display screen and a second touch panel on the second display screen.

The memory stores notification information to be notified to the user. The control module is operable to display information on the display screens based on an operation on the touch panels by the user. The control module is further operable to display the notification information continuously in an area between a first location and a second location on the first display screens, if the user moves a predefined area from the first location to the second location on the first touch screen in a direction toward the second touch panel, to display the notification information continuously in an area between the first location and the second location on the first display screens.

In another embodiment, a method for controlling an electronic device comprising a plurality of display screens is: storing a plurality of applications; receiving an operation operated by a user on a touch panel; displaying information on a display screen; storing information to be notified to the user; and display, if a user moves a predefined area from a first location to a second location on the first touch screen, to display the notification information continuously in an area between the first location and the second location on the first display screens.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of a perspective view of an exemplary electronic device in a standard-flat state according to an embodiment of the disclosure.

FIG. 2 is an illustration of a perspective view of the exemplary electronic device in a separated-flat state according to an embodiment of the disclosure.

FIG. 3 is an illustration of a perspective view of the exemplary electronic device in a tilt state according to an embodiment of the disclosure.

FIG. 4 is an illustration of a perspective view of the exemplary electronic device in a closed state according to an embodiment of the disclosure.

FIGS. 5A to 5C are illustrations of side views of the electronic device illustrated in FIGS. 1 to 3 to show an operation of changing states from 5A the standard-flat state illustrated FIGS. 1 to 5B the separated-flat state illustrated FIG. 2, then to 5C the tilt state illustrated FIG. 3 according to an embodiment of the disclosure.

FIGS. 6A to 6C are illustrations of side views of the electronic device to show an operation of further changing states from 6A forwarded-tilt state to 6B forwardly-slid state 6C the closed state illustrated FIG. 4 according to an embodiment of the disclosure.

FIG. 7 is an illustration of an exemplary schematic functional block diagram of an electronic device according to an embodiment of the disclosure.

FIG. 8 is an illustration of an exemplary flow diagram showing a process to operate applications according to an embodiment of the disclosure.

FIG. 9 is an illustration of exemplary display screens when two displayed applications are displayed on the display screens while a plurality of applications including two displayed applications are being operated according to an embodiment of the disclosure.

FIG. 10 is an illustration of exemplary display screens when a notification bar is displayed according to an embodiment of the disclosure.

FIG. 11 is an illustration of exemplary display screens when a notification bar is operated by a flick operation.

FIG. 12 is an illustration of exemplary display screens when a notification bar is dragged from a first display screen into a second display screen.

FIG. 13 is an illustration of exemplary display screens continuously displaying contents of notification information (or notifications) in a plurality of display screens.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, GPS's or navigation systems, health equipments, and the like. As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

Embodiments of the present disclosure relate to a mobile electronic device having a plurality of display screens and operable device such as touch panels with improved operability for operation of running applications.

According to an electronic device of the present disclosure, a control module is operable to continuously display notification information stored in a memory across a plurality of display screens when a user moves a predefined area on a touch panel toward the other display screen by a flick operation, a drag operation or other operations. That is, the electronic device is able to display information to be notified to a user in a large area including the other display screen. As a result, the user is able to recognize information correctly due to the high visibility. Even when another application is displayed on the other display screen, the information displayed continuously across the other display screen will hide the application, and the user's confusion of the information is prevented.

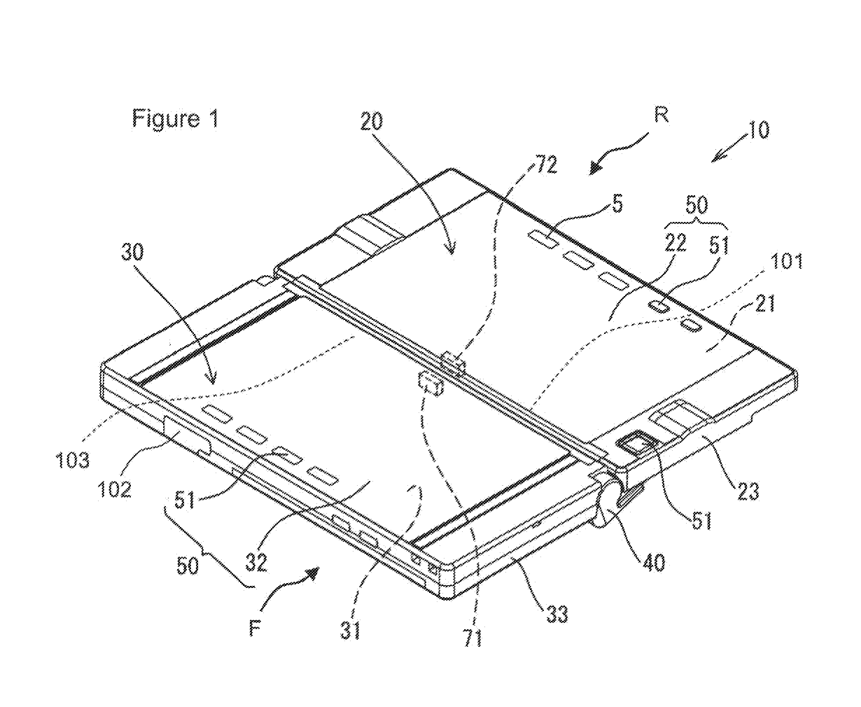

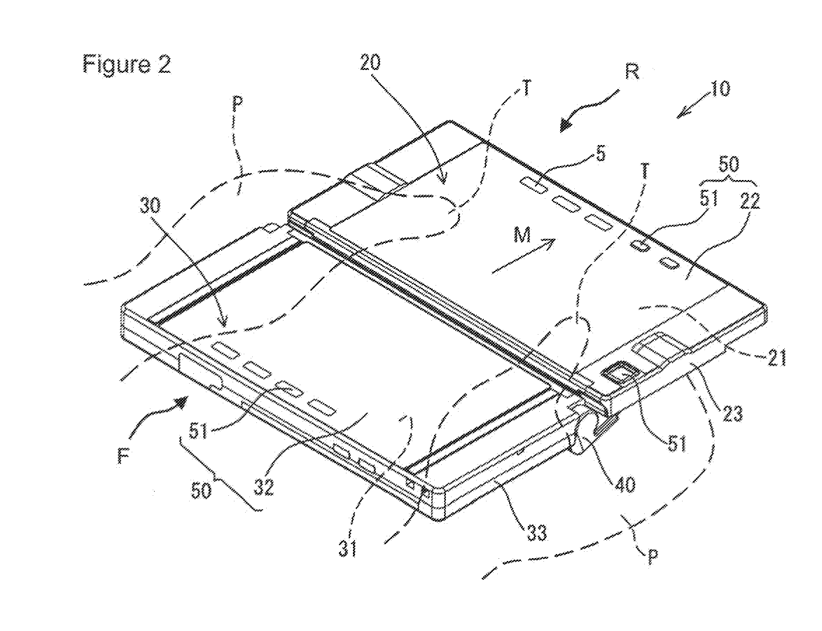

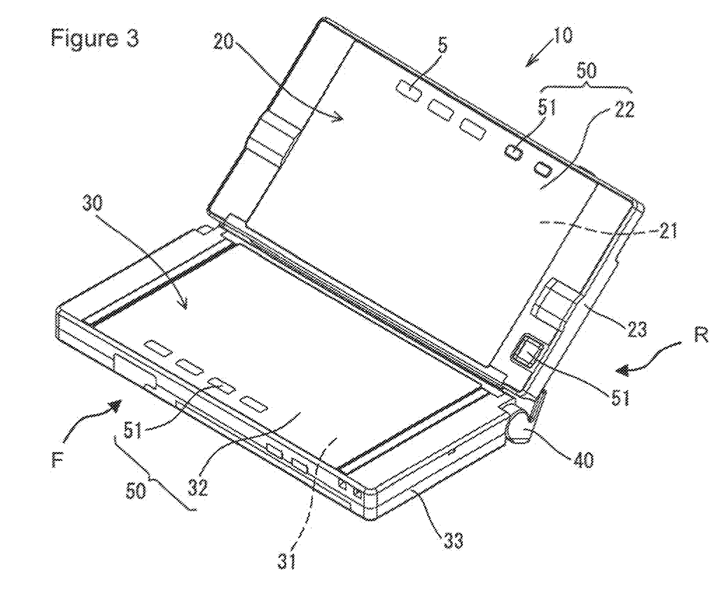

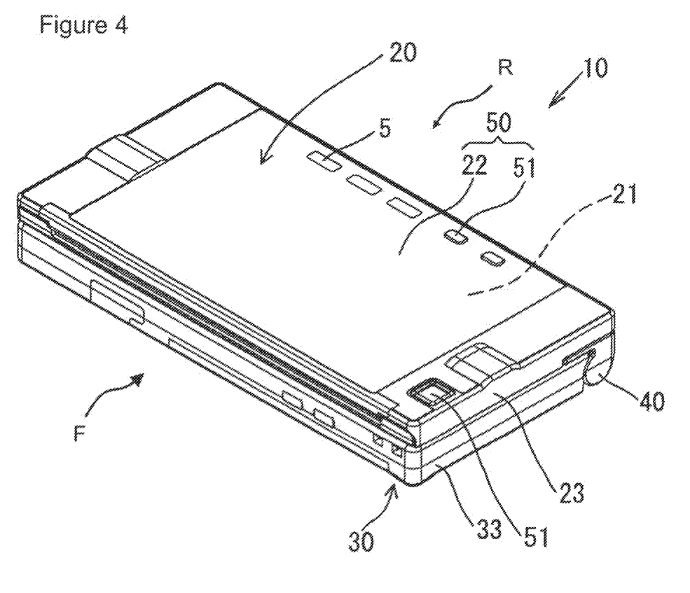

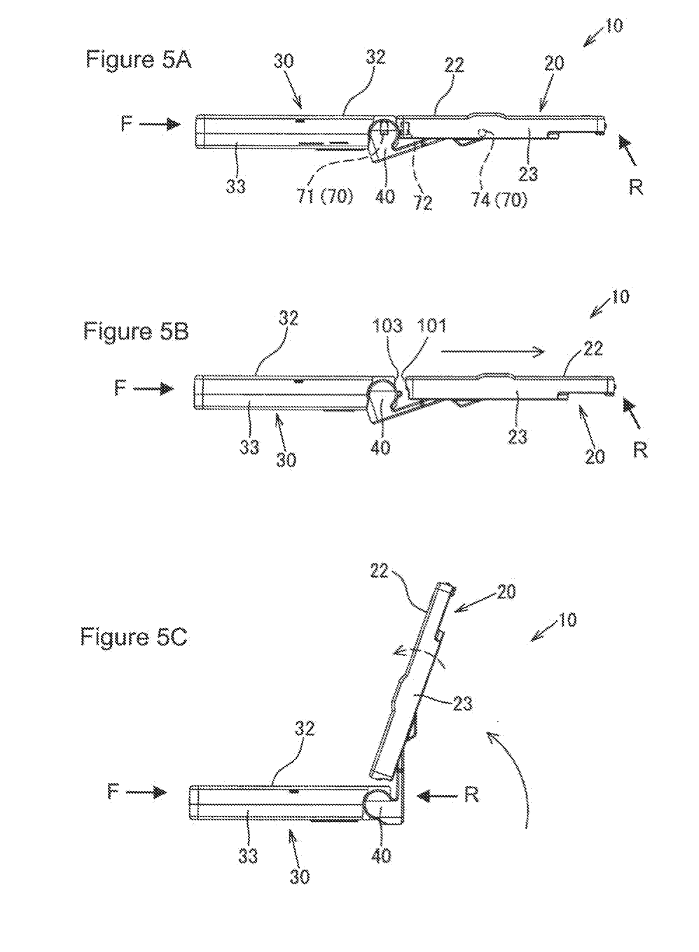

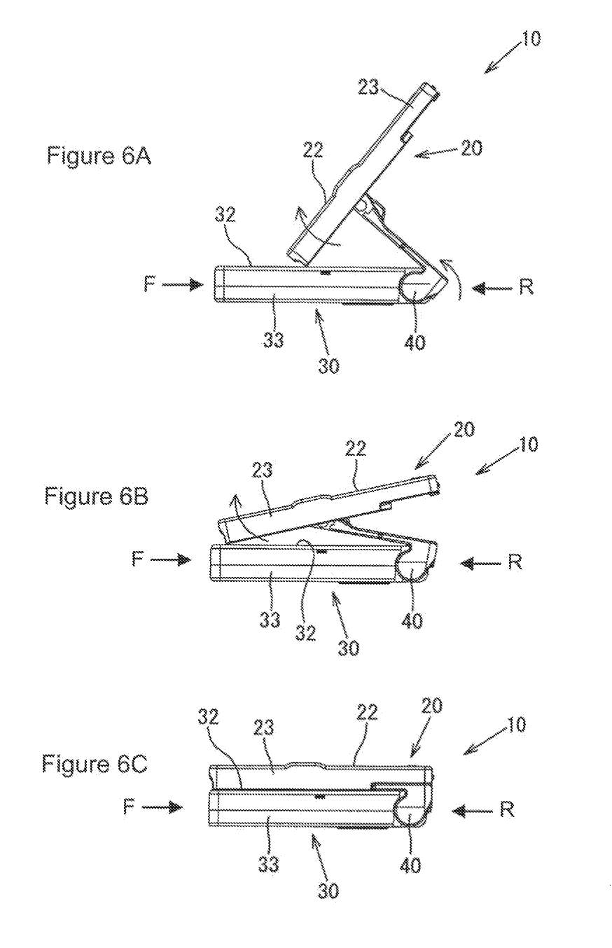

FIG. 1 is an illustration of a perspective view of an exemplary electronic device in a standard-flat state according to an embodiment of the disclosure. FIG. 2 is an illustration of a perspective view of the exemplary electronic device in a separated-flat state according to an embodiment of the disclosure. FIG. 3 is an illustration of a perspective view of the exemplary electronic device in a tilt state according to an embodiment of the disclosure. FIG. 4 is an illustration of a perspective view of the exemplary electronic device in a closed state according to an embodiment of the disclosure. FIGS. 5A to 5C are illustrations of side views of the electronic device illustrated in FIGS. 1 to 3 to show an operation of changing states from 5A the standard-flat state illustrated FIGS. 1 to 6B the separated-flat state illustrated FIG. 2, then to 5C the tilt state illustrated FIG. 3 according to an embodiment of the disclosure. FIGS. 6A to 6C are illustrations of side views of the electronic device to show an operation of further changing states from 6A forwarded-tilt state to 6B forwardly-slid state 6C the closed state illustrated FIG. 4 according to an embodiment of the disclosure.

In an electronic device 10 according to an embodiment of the present disclosure, as illustrated in FIGS. 1 to 6, screens 21, 31 are capable of displaying information such as characters, graphics, images, motion pictures or the like. A plurality of display modules 20, 30, including touch panels 22, 32 are operable by being touched by a user on the surface of the display screen. The touch panels 22, 32, are coupled to each other and move by opening/closing or sliding relative to each other by a connection module 40.

FIGS. 1 to 6 show a state in a second display module 30 is arranged horizontally such that the second display screen 31 faces upward, and the facing direction of the second display module 30 is referred to as the “top” while the back face side thereof is referred to as the “bottom”; whereas, in FIGS. 1 to 4, the front left side of the figure is referred to as the “front” (“F”) and the back right side thereof is referred to as the “rear” (“R”), while in FIGS. 5 and 6, the left side in the figure is referred to as the “front” (“F”) and the right side thereof is referred to as the “rear” (“R”). As for “left” and “right,” each means the left and the right directions viewed in the aforementioned “front” direction. With regard to the first display module 20 and the second display module 30, the end module on the front side shown in FIG. 1 is referred to as the “base end” 101 and the end module on the rear side is referred to as the “rear end” 102.

The display module 20 includes a display screen 21, which is capable of displaying various kinds of information, in a first case 23 having an upper face opened, thereby being recognizable visually from the opening side thereof. In the same manner, the display module 30 includes a display screen 21, which is capable of displaying various kinds of information, in a second case 33 having an upper face opened, thereby being recognizable visually from the opening side thereof.

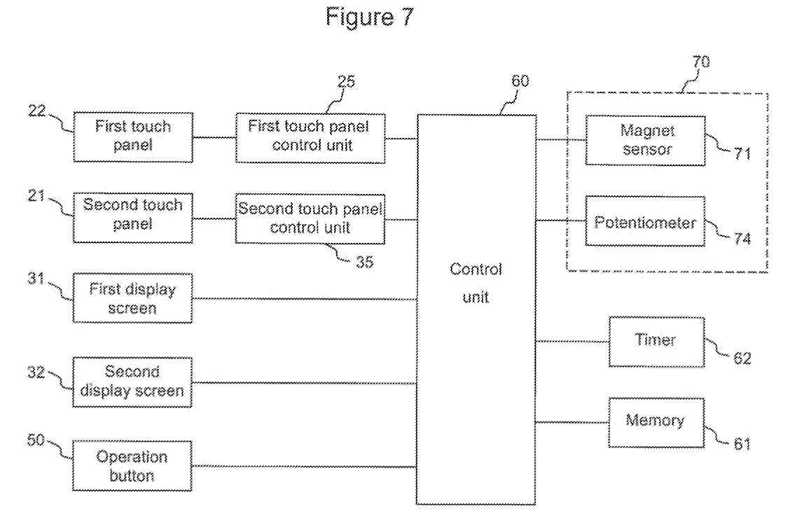

Each of the first and second display modules 20, 30 may comprise a liquid crystal display as an example of a display screen. Each of the first and second display modules 20/30 is electrically coupled to a control module 60 (shown in FIG. 7) to display various kinds of information as described in more detail below. In FIG. 1, a display module positioned on the rear side R is referred to as a first display module 20 and a display module positioned on the front side F is referred to as a second display module 30.

The first display screen 21 includes a first touch panel 22 on the opening side thereof while the second display screen 31 includes a second touch panel 32 on the opening side thereof. The first and second touch panels 22, 32 are operable by being touched by a user. The first and second touch panels 22, 32 are arranged so as to close the opening of the first and second cases 23, 33 respectively and are transparently formed so that the display screens 21, 31 become visually recognizable. The first and second touch panels 22, 32 may comprise, for example but without limitation, a capacitive type touch panel, a resistive film type touch panel, or other types of touch panel.

The first and second touch panels 22, 32 are electrically coupled to the control module 60 via touch panel control modules 25, 35 respectively such that when a user operates the first and/or second touch panels 22, 32, the corresponding coordinate information is input into the control module 60 via first and second touch panel control modules 25, 35 respectively so as to be used for various kinds of operations or the like. The user can operate/activate the first and/or second touch panels 22, 32 by touching her/his finger thereon, or other means. Examples of operations by a user using the touch panels 22, 32 include tapping or double tapping by relatively brief contact with the touch panels 22, 32, or dragging, flicking, pinching, and long touching which involve longer contact time on the touch panels 22, 32 than the former.

A plurality of operation buttons 51 are arranged near the touch panels 22, 32 and/or on the peripheral surface of the case 33, forming an operation module 50 together with the touch panels 22, 32. A power supply button or the like is an example of an operation button 51. These operation buttons 51 are also electrically coupled to the control module 60 so as to make various kinds of controls possible by operating the operation buttons 51.

The first display module 20 and the second display module 30 are movable relative to each other by the connection module 40. The first display module 20 is made slidable and rotatable with respect to the second display module 30 in the electronic device 10 in the present embodiment.

The connection module 40 may couple an approximate center in a direction from the front F to the rear R on the back face side 101 of the first case 23 and a side 103 of the second case 33. The connection module 40 may be configured by a plurality of arms or other means. The first display module 20 is made slidable and rotatable by the connection module 40 in an approaching and separating directions with respect to the second display module 30, as described in more detail below. Alternatively, the connection module 40 may couple the first display module 20 and the second display module 30 by only sliding or only rotating the connection module 40.

The relative position of the first display module 20 and the second display module 30 may be detected by a shift detection sensor 70. The shift detection sensor 70 may comprise, for example but without limitation, a contact type switch that detects the approach or separation of the first display module 20 and the second display module 30, a non-contact type sensor comprising a magnet 72 and a magnet sensor 71, a potentiometer that detects the relative angle change between the first display module 20 and the second display module 30 or between the first and second display modules 20 30 and the connection module 40, or other sensors. The shift detection sensor 70 is also electrically coupled to the control module 60 (shown in FIG. 7).

In the shift detection sensor 70, a magnet 72 is embedded in the first display module 20 at the base end thereof while a magnet sensor 71 is housed in the second display module 30, which comes close to the magnet 72 in a standard-flat state, at a side end thereof. The shift detection sensor 70 can detect whether the first display module 20 and the second display module 30 are approaching or being separated. Thereby, whether the electronic device 10 is in the standard-flat state shown in FIGS. 1 and 5A or in a different state may be detected.

As illustrated in FIG. 5A, a potentiometer 74 is arranged at the connection portion of the connection module 40 and the first display module 20 in order to detect the rotation of the first display module 20 with respect to the connection module 40.

FIG. 7 is an illustration of an exemplary schematic functional block diagram of an electronic device according to an embodiment of the disclosure.

The control module 60 is configured to support functions of the electronic device 10. The control module 60 may comprise a CPU or the like. The control module 60 may control operations of the electronic device 10 so that processes of the electronic device 10 are suitably performed. For example, the control module 60 may control starting various kinds of applications installed in the electronic device 10 and is also capable of simultaneously starting a plurality of applications.

The control module 60, may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices. e.g., a combination of a digital signal processor and a microprocessor, a plurality of microprocessors, one or more microprocessors in conjunction with a digital signal processor core, or any other such configuration.

The control module 60 is electrically coupled to the first display screen 21 and the second display screen 31 and is capable of displaying information regarding each application.

The first touch panel 22 and the second touch panel 32 are electrically coupled to the control module 60 via a first touch panel control module 25 and a second touch panel control module 35 respectively. Inputs by a user from the first touch panel 22 and the second touch panel 32 are transmitted to the control module 60 via the touch panel control modules 25 and 35 respectively, and the control module 60 edits and/or operates information on the display screen 21 and 31 in response to the input.

The control module 60 is also electrically coupled to a memory 61, a timer 62, and an operation display module 63 as explained in more detail below as well as the operation buttons 51.

The memory 61 may be any suitable data storage area with suitable amount of memory that is formatted to support the operation of the electronic device 10. The memory 61 is configured to store, maintain, and provide data as needed to support the functionality of the electronic device 10 in the manner described below. In practical embodiments, the memory 61 may comprise, for example but without limitation, a non-volatile storage device (non-volatile semiconductor memory, hard disk device, optical disk device, and the like), a random access storage device (for example, SRAM, DRAM), or any other form of storage medium known in the art.

The first display module 20 and the second display module 30 coupled by the connection module 40 may be moved relative to each other by the following procedure.

In FIG. 1, the first display module 20 and the second display module 30 have the first display screen 21 and the second display screen 31 on approximately the same plane while the base side 101 of the first case 23 and the side 103 of the second case 33 are adjacent to or in contact with each other (referring FIGS. 5A and 5B). The side view of the electric device illustrated in FIG. 1 is FIG. 5A. This state is referred to as a “standard-flat state.”

In the standard-flat state, the first display screen 21 and the second display screen 31 become continuous and may visually be recognized as one screen, while the first touch panel 22 and the second touch panel 32 may also be operated as if they are one continuous touch panel.

The information signal indicating that the display modules 20 and 30 are in the standard-flat state is detected by the magnet sensor 71 and may be transmitted to the control module 60.

As illustrated in FIG. 2, in the standard-flat state, when the user pushes the first touch panel 22 with both thumbs T backwards or in a separating direction M while supporting the back face of the second case 33 with four fingers of a hand P and supporting the second touch panel 32 with a ball, the first display module 20 slides into the separating direction M with respect to the second display module 30. This state is referred to as a “separated-flat state,” the side view of which is shown in FIG. 5B.

Shifting from the standard-flat state to the separated-flat state is detected by the magnet sensor 71 and a signal indicating the shifting may be transmitted to the control module 60.

In the separated-flat state shown in FIG. 2, when the tip end side of the first display module 20 is pinched while pulling up the first display module 20 such that the first display screen 21 inclines in the front side direction, the first display screen 21 may be tilted with respect to the second display screen 31 as illustrated in FIGS. 3 and 5C. This state is referred to as a “tilted state.” This operation may also be conducted by pinching and pulling the first display module 20 with the thumb and an index finger of the other hand while pressing the second case 33 with one hand.

As described above, the rotation of the first display module 20 is detected by the potentiometer 74 and a signal indicating the rotation may be transmitted to the control module 60.

While in a tilted state, because the first display screen 21 is tilted while horizontally retaining the second display screen 31, it is easy to visually recognize the first display screen 21. For example, displaying information such as characters on the first display screen 21, displaying a keyboard, for example, on the second display screen 31, and operating the second touch panel 32 make it possible to realize an electronic device 10 that is good in operability.

The first display module 20 and the second display module 30 may be brought into a closed state with the first display module 20 on the top side such that the second display module 30 is no longer visually recognized as illustrated in FIG. 4 and FIG. 6C by pushing down the first display module 20 toward the back with respect to the connection module 40 in the tilted state as illustrated FIG. 6A, and further pressing down the first display module 20 downwards such that the tip end of the first display module comes close to the tip end of the second display module 30 as illustrated FIG. 6B.

As described above, the rotation of the first display module 20 may be detected by the potentiometer 74 and a signal indicating the rotation may be transmitted to the control module 60.

In a closed state, only the first display module 20 may be visually recognized and only the first touch panel 22 as well as the operation buttons 51 exposed on the surface may be operable, while the second display module 30 is no longer visually recognizable and the second touch panel 32 is inoperable as well.

The closed state is suitable not only for single-screen use, but also for disuse and for carrying, allowing the electronic device 10 to be downsized.

The reverse operation of the above involves shifting from the closed state to a tilted state or further to a standard-flat state.

In general operations, the control module 60 is capable of displaying information on the first display screen 21 or the second display screen 31, controlling various kinds of operations based on inputs from the first touch panel 22 or the second touch panel 32 and operation buttons 51, and switching information displayed on the first display screen 21 with information displayed the second display screen 31 based on the shift detection sensor 70.

The memory 61 stores notification information (hereinafter, “notification”) to be notified to a user regarding an operation system or applications.

Specifically, the notification 84 may include an “Alarm” activated by an operation system, a “reception of new message (New Message)” generated by mail application, “information of application update (Application Update)” and/or “display of incoming call information” and/or “display of missed call information.”

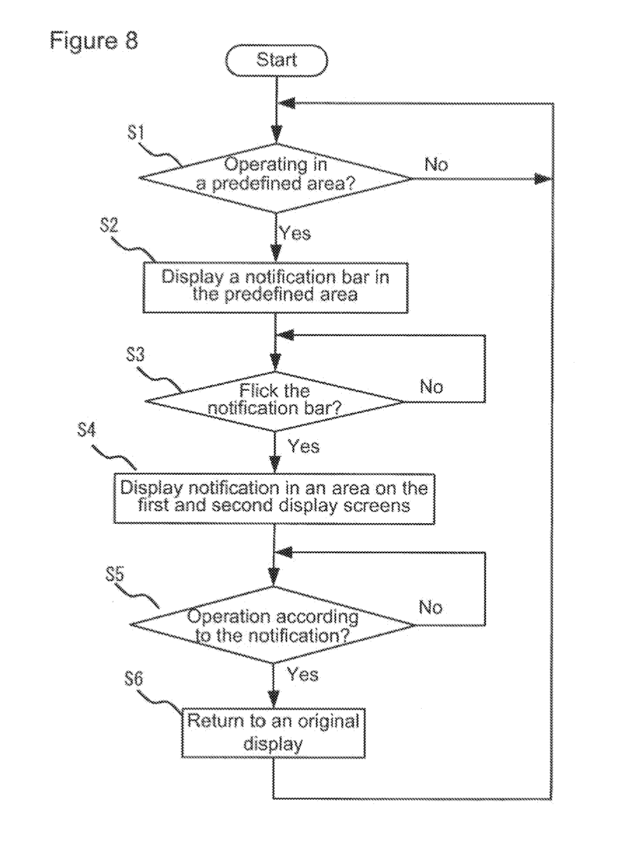

The control unit 60 is also electronically connected to the control module 63 shown in FIG. 7. The control module 63 is operable to display the notification 84 stored in the memory 61 on the display unit 21 and/or 31. Such operation flow is shown in FIG. 8.

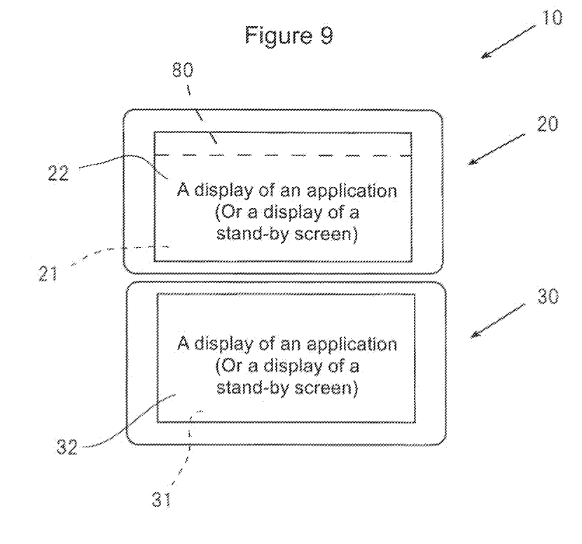

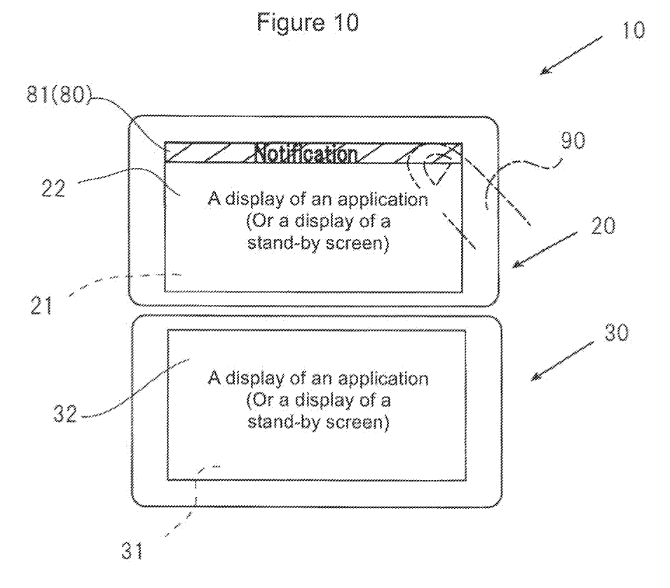

FIG. 8 is an illustration of an exemplary flow diagram showing a process to operate applications according to an embodiment of the disclosure. FIG. 9 is an illustration of exemplary display screens when two displayed applications are displayed on the display screens while a plurality of applications including two displayed applications are being operated according to an embodiment of the disclosure. FIG. 10 is an illustration of exemplary display screens when a notification bar is displayed according to an embodiment of the disclosure.

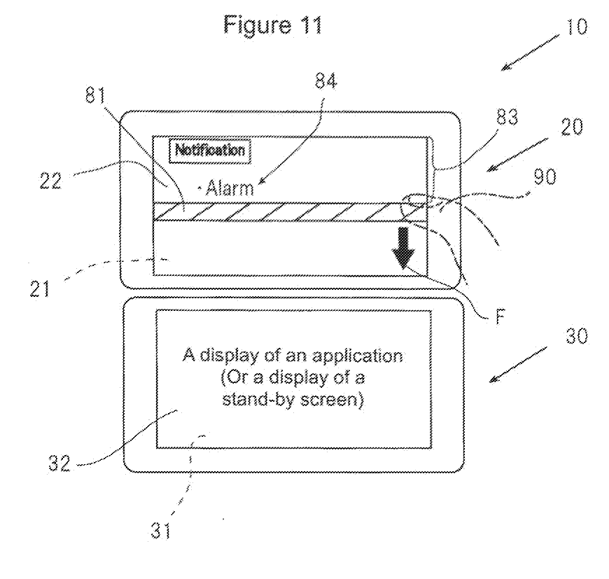

Specifically, as illustrated in FIG. 9, when the control unit 60 starts one or more applications and displays respective applications on the first display screen 21 and on the second display screen 31, if a user performs an operation with his/her finger 90 in the predefined area 80 (shown in the upper area of the first touch panel 22 in FIG. 9) on the first touch panel 22 and/or the second touch panel 32 (Task S1 in FIG. 8), a notification bar 81 is displayed in the corresponding predefined area 80 as shown in FIG. 10 (Task S2). In the same manner, when a standby screen is displayed on one or both of the first display screen 21 and the second display screen 31, a notification bar 81 is displayed if a user performs an operation with his/her finger 90 in the predefined area 80 on the first touch panel 22,and/or the second touch panel 32. The notification bar 81 may be located a top portion of an area 83 (shown in FIG. 11) where the notification is displayed.

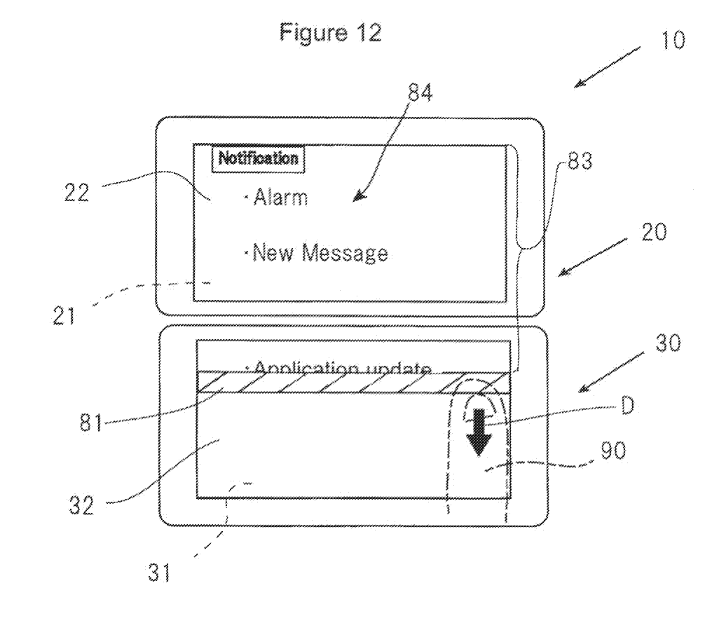

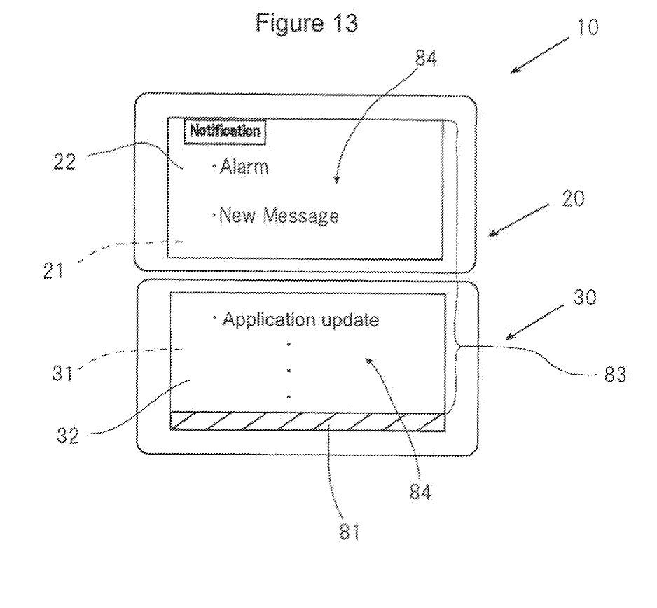

FIG. 11 is an illustration of exemplary display screens when a notification bar is operated by a flick operation. FIG. 12 is an illustration of exemplary display screens when a notification bar is dragged from a first display screen into a second display screen. FIG. 13 is an illustration of exemplary display screens continuously displaying contents of notifications in a plurality of display screens.

When the notification bar 81 is displayed in the predefined area 80 on the first display screen as illustrated in FIG. 10, a user flicks or drags the notification bar 81 toward the second display screen 31 as shown in FIG. 11 (Task S3). As a result, the control module 63 moves the notification bar 81 to the bottom portion of the second display screen 31 as shown in FIG. 13. Then, the control module 63 displays the notification 84 stored in the memory 61 in the display area 83 that is the moving path of the notification bar 81 (Task S4).

Accordingly, the notification 84 may be continuously displayed in the large area in not only the first display screen 21 but also the second display screen 31. Thus, more information may be displayed, and a user is able to accurately recognize information due to the high visibility. Even if an application or the like has been displayed on the second display screen 31, the notification 84 is displayed on the second display screen 31. Therefore, a user does not misinterpret the notifications as the information related to the application previously displayed on the second display screen 31.

A user may perform an operation corresponding to the notification 84 continuously displayed across the first display screen 21 and the second display screen 31 (Task S5). As a result, the control unit 60 is able to execute the corresponding operation. Examples of the operation may include, but not limited to, “Dismiss Alarm” or “Display Tasks (schedule)” to be performed in the case of an “Alarm,” “List Incoming Mails” or “Display an Incoming Mail” in the case of mail software, “Display Detailed Information of an Incoming Call” or “Display Detailed Information of a Missed call” in the case of phone calls, and the details and/or downloads in the case of updating information for an application. Upon completion of an operation, the application information displayed before the operation is once again displayed on the second display screen 31 (Task S6).

In the above embodiments, the area for operating the notification bar 81 is provided on the first touch panel 22, but the area may also be provided on the second display screen 31. In this case, the notification 84 may be continuously displayed on the first display screen 21 and the second display screen 22.

The notification bar 81 may be displayed to enhance the operability in terms of a user's visual recognition, but the notification bar 81 may not be also displayed on the first display screen 21. In this case, when a user touches in the area corresponding to the predefined area 80 on the touch panel 22 and immediately performs a flick operation or a drag operation toward the second display screen 31, the notification 84 may be also displayed.

In the above embodiments, the notification bar 81 is dragged from the top part of the first display screen 21 to the bottom part of the second display screen 31 to display the notification 84. However, the movement of the notification bar 81 may be stopped by terminating the drag operation of the notification bar 81 along the way, allowing the display area 83 for the notification to be any desired size.

Additionally, as to the operation of dragging the notification bar 81 to the second touch panel 32 as described in FIG. 12, if the operation is performed with the finger 90, the drag operation extending over the first touch panel 22 and the second touch panel 32 is recognized as a continuous drag operation even though there are spaces between the first touch panel 22 and the second touch panel 32, because the touched area is relatively large. However, when the spaces between touch panels 22 and 32 are large, or when the touch panels 22 and 32 are operated with a stylus or the like, a signal of a drag operation may be interrupted between the touch panel 22 and 23. In this case, a continuous drag operation may be determined when the second touch panel control unit 35 receives a signal of a drag operation within a predefined time after the first touch panel control unit 25 receives a signal of a drag operation.

Embodiments described above can be applicable to any electronic device 10 comprising a plurality of display screens without being limited to those with display screens that are relatively slidable and rotatable with respect to each other. For example, the application is also possible with those electronic devices having relatively sliding or rotating display screens or electronic devices and the like in which a plurality of display screens are arranged side by side on one case.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. An electronic device comprising:
a plurality of display screens comprising a first display screen and a second display screen;
a plurality of touch panels on respective display screens including a first touch panel on the first display screen and a second touch panel on the display screen, operable to be operated by a user; and
a memory electronically coupled to the control unit, and storing notification information to be notified to the user; and
a control module electrically coupled to the display screens and the touch panels, and operable to:
display information on the display screens based on an operation on the touch panels by the user; and
display the notification information continuously in an area between a first location and a second location on the first display screens if the user moves a predefined area from the first location to the second location on the first touch screen.

2. The electronic device according to claim 1, wherein
if the predefined area is moved from the second location further to a third location on the second touch screen, the operable control module displays the notification information continuously on the first display screen and the second display screen between the first location to the third location.

3. The electronic device according to claim 2, wherein the control module is further operable to determine a drag operation from the first touch panel to the second touch panel if the control module receives a signal indicating the drag operation from the second touch panel within a predetermined period of time after receiving a signal indicating the drag operation from the first touch panel.

4. The electronic device according to claim 1, further comprising a
a connection module operable to couple the first display screen and the second display screen and relatively move the first display screen and the second display screen.

5. A method for controlling an electronic device comprising a plurality of display screens, the method comprising:
storing a plurality of applications;
displaying one of the applications on a first display screen;
storing notification information in a memory to be notified to the user.
receiving an operation operated by a user on a touch panel;
displaying, if a user moves a predefined area from a first location on the first touch screen to a second location towards a second display, the notification information in an area between the first location and the second location on the first display screen.

6. The method according to claim 5, wherein
the second location is located on the second display, and
the area is located continuously on the first display screen and on the second display screen.
